(19) United States
(12) Patent Application Publication
(10) Pub. No.: US 2009/0228355 A1
(43) Pub. Date: Sep. 10, 2009

(54) AMELIORATION OF UNSOLICITED ADVERTISEMENTS IN A VIRTUAL UNIVERSE THROUGH AVATAR TRANSPORT OFFERS

(76) Inventors: Christopher J. Dawson, Arlington, VA (US); Carl P. Gusler, Austin, TX (US); Rick A. Hamilton, II, Charlottesville, VA (US); Clifford A. Pickover, Yorktown Heights, NY (US)

Correspondence Address: HOFFMAN WARNICK LLC, 75 STATE ST, 14TH FLOOR, ALBANY, NY, 12207, US

(21) Appl. No.: 12/044,459

(22) Filed: Mar. 7, 2008

(51) Int. Cl. G06Q 30/00

(52) U.S. Cl. 705/14

(57) ABSTRACT

An approach that ameliorates an offer of transport to a virtual region within the virtual universe for exposure to an unsolicited advertisement is described. In one embodiment, there is a transport invitation detection component configured to detect an offer of transport to a virtual region within the virtual universe for exposure to an unsolicited advertisement. An advertisement analysis component is configured to determine whether to present the offer of transport to an avatar targeted to receive the unsolicited advertisement.

### FIELD OF THE INVENTION

This invention relates generally to virtual universes, and more specifically to ameliorating unsolicited advertisements made to avatars existing within the virtual universes through transport offers to virtual regions for exposure to the unsolicited advertisements.

### BACKGROUND OF THE INVENTION

Virtual universes or virtual worlds are computer-based simulated environments intended for its users to inhabit and interact via avatars, which are personas or representations of the users of the virtual universes and generally take the form of two-dimensional or three-dimensional human or fantastical representations of a person's self. These types of virtual universes are now most common in massive multiplayer online games, such as Second Life which is a trademark of Linden Lab in the United States (US), other countries or both. Avatars in these types of virtual universes, which can number well over a million, have a wide range of business and social experiences.

These avatars create, manipulate and buy and sell every aspect of their virtual lives. It is common in some of these virtual universes to exchange millions of US dollars on a monthly basis in support of these virtual experiences. As a result, these virtual universes provide a fertile ground for advertising goods and services, whether real-life or virtual, to the avatars that exist in these virtual universes. Currently, advertising for goods and services occurs in these virtual universes through conventional methods and mechanisms (i.e., billboards, posters, flyers, etc.). As the marketing power of these virtual universes becomes more apparent to businesses, it will become desirable to develop other approaches of providing advertisements to avatars in these virtual universes. It is likely that these new approaches of providing advertisements will result in the avatars receiving a deluge of unsolicited advertisements. Methodologies that can manage this expected deluge of unsolicited advertisements in virtual universes will be desirable.

### SUMMARY OF THE INVENTION

In one embodiment, there is a method for ameliorating an offer of transport that a first avatar online in a virtual universe receives from a second avatar online in the virtual universe for teleporting to another virtual region within the virtual universe for exposure to an unsolicited advertisement. In this embodiment, the method comprises: detecting that the second avatar has sent the first avatar the offer of transport to the virtual region for exposure to the unsolicited advertisement; and determining whether to present the offer of transport to the first avatar.

In a second embodiment, there is an advertising amelioration tool for use in a virtual universe. In this embodiment, the tool comprises a transport invitation detection component configured to detect an offer of transport to a virtual region within the virtual universe for exposure to an unsolicited advertisement. An advertisement analysis component is configured to determine whether to present the offer of transport to an avatar targeted to receive the unsolicited advertisement.

In a third embodiment, there is a computer-readable medium storing computer instructions, which when executed, enables a computer system to ameliorate an offer of transport made to a first avatar online in a virtual universe from a second avatar online in the virtual universe for teleporting to another virtual region within the virtual universe for exposure to an unsolicited advertisement. In this embodiment, the computer instructions comprise detecting that the second avatar has sent the first avatar the offer of transport to the virtual region for exposure to the unsolicited advertisement; receiving the offer of transport to the virtual region for exposure to the unsolicited advertisement from the second avatar; and determining whether to present the offer of transport to the first avatar.

In a fourth embodiment, there is a method for deploying an advertising amelioration tool for use in a computer system that ameliorates an offer of transport that a first avatar online in a virtual universe receives from a second avatar online in the virtual universe for teleporting to another virtual region within the virtual universe for exposure to an unsolicited advertisement. In this embodiment, a computer infrastructure is provided and is operable to detect that the second avatar has sent the first avatar the offer of transport to the virtual region for exposure to the unsolicited advertisement; and determine whether to present the offer of transport to the first avatar.

### BRIEF DESCRIPTION OF THE DRAWINGS

FIG. 1 shows a high-level schematic diagram showing a networking environment for providing a virtual universe according to one embodiment of this invention;

FIG. 2 shows a more detailed view of a virtual region shown in the virtual universe of FIG. 1;

FIG. 3 shows a more detailed view of the virtual universe client shown in FIG. 1;

FIG. 4 shows a more detailed view of some of the functionalities provided by the server array shown in FIG. 1;

FIG. 5 shows an advertising amelioration tool according to one embodiment of this invention that operates in the environment shown in FIG. 1;

FIG. 6 shows an example of a graphic user interface panel generated from the advertising amelioration tool; and

FIG. 7 shows a schematic of an exemplary computing environment in which elements of the networking environment shown in FIG. 1 may operate.

### DETAILED DESCRIPTION OF THE INVENTION

Embodiments of this invention are directed to a technique for ameliorating offers that an avatar in a virtual universe may receive for teleporting to a region within the universe for exposure to an unsolicited advertisement. The embodiments of this invention ameliorate these offers for transport by filtering offers that an avatar would not have an interest in receiving because the avatar extending the offer for transport is unknown or is known to be of ill repute or because the location in which transport is being offered is not of interest to the avatar or is known to be conducting illicit or unsavory activities. If these offers for transport are suitable for an avatar to receive, additional embodiments can assist the avatar in discriminating these offers for transport by providing additional information that the avatar can use to decide whether to ultimately accept an offer for transport.

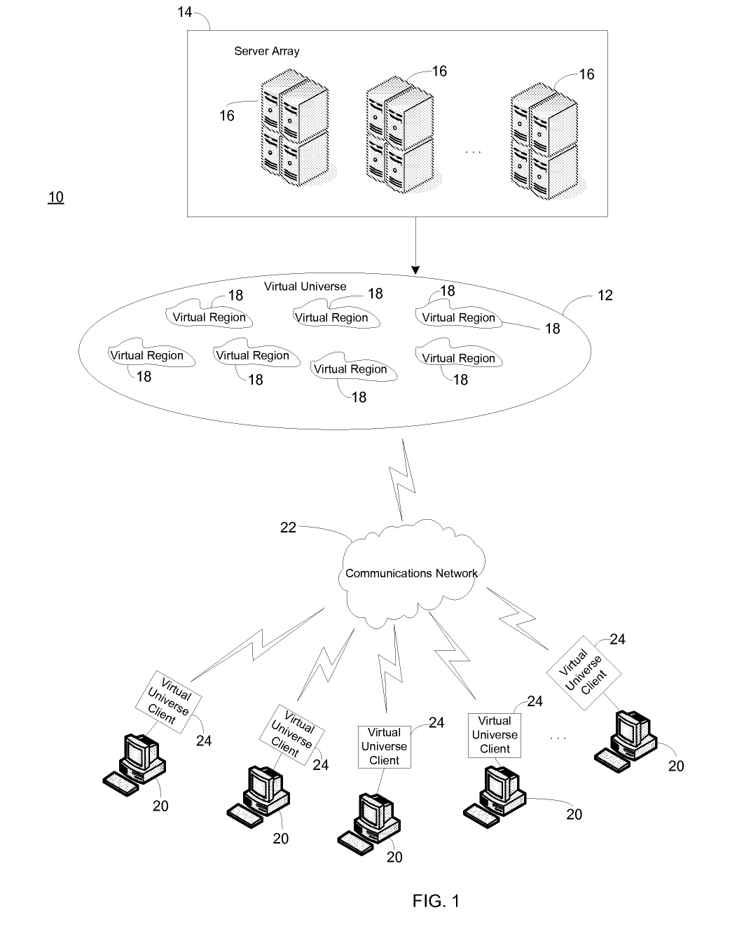

FIG. 1 shows a high-level schematic diagram showing a networking environment 10 for providing a virtual universe 12 according to one embodiment of this invention in which a service for ameliorating offers of transport to regions within the universe for exposure to an unsolicited advertisement can be utilized. As shown in FIG. 1, the networking environment 10 comprises a server array or grid 14 comprising a plurality of servers 16 each responsible for managing a portion of virtual real estate within the virtual universe 12. A virtual universe provided by a typical massive multiplayer online game can employ thousands of servers to manage all of the virtual real estate. The content of the virtual real estate that is managed by each of the servers 16 within the server array 14 shows up in the virtual universe 12 as a virtual region 18.

Like the real-world, each virtual region 18 within the virtual universe 12 comprises a living landscape having things such as buildings, stores, clubs, sporting arenas, parks, beaches, cities and towns all created by residents of the universe that are represented by avatars. These examples of items are only illustrative of some things that may be found in a virtual region and are not limiting. Furthermore, the number of virtual regions 18 shown in FIG. 1 is only for illustration purposes and those skilled in the art will recognize that there may be many more regions found in a typical virtual universe. FIG. 1 also shows that users operating computers 20 interact with the virtual universe 12 through a communication network 22 via a virtual universe client 24 that resides in the computer. Below are further details of the virtual universe 12, server array 14, and virtual universe client 24.

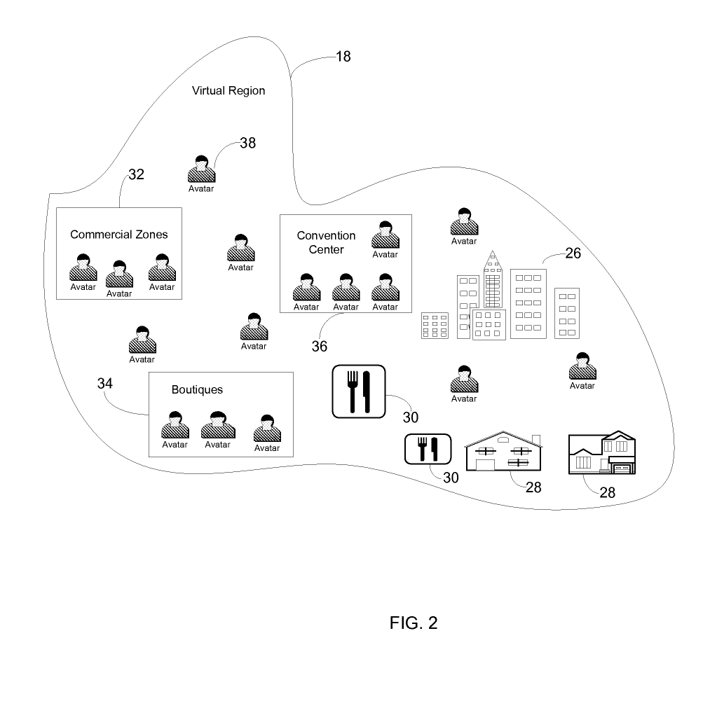

FIG. 2 shows a more detailed view of what one virtual region 18 shown in the virtual universe 12 of FIG. 1 may comprise. As an example, the virtual region 18 shown in FIG. 2 comprises a downtown office center 26, homes 28, restaurants 30, commercial zones 32 and boutiques 34 for shopping and a convention center 36 for meetings and various conventions. Residents or avatars 38, which as mentioned above, are personas or representations of the users of the virtual universe, that roam all about the virtual region by walking, driving, flying or even by teleportation or transportation, which is essentially moving through space from one point to another, more or less instantaneously. These examples of items in the virtual region 18 shown in FIG. 2 are only illustrative of some things that may be found in a virtual region and those skilled in the art will recognize that these regions can have many more items that can be found in a real-life universe as well as things that do not presently exist in real life.

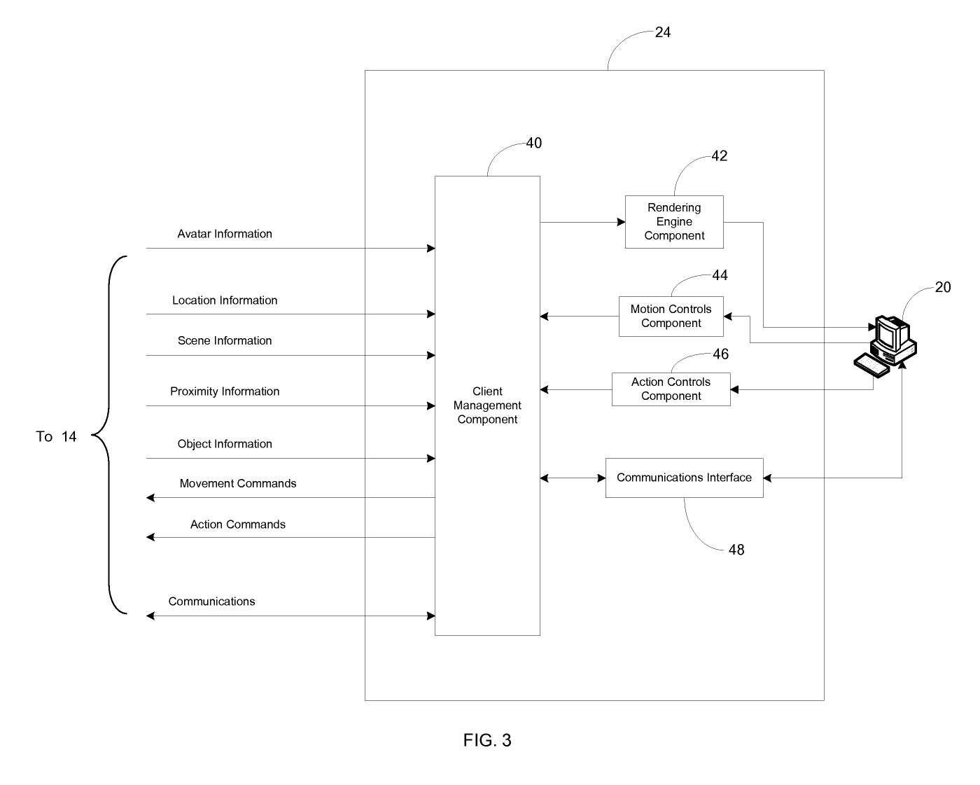

FIG. 3 shows a more detailed view of the virtual universe client 24 shown in FIG. 1. The virtual universe client 24, which enables users to interact with the virtual universe 12, comprises a client management component 40, which manages actions, movements and communications made by a user through computer 20, and information received from the virtual universe through the server array 14. A rendering engine component 42 enables the user of the computer 20 to visualize his or her avatar within the surroundings of the particular region of the virtual universe 12 that it is presently located. A motion controls component 44 enables the user to make movements through the virtual universe. In one embodiment, movements through the virtual universe can include for example, walking, running, driving, flying, etc. An action controls component 46 enables the user to perform actions in the virtual universe such as buying items for his or her avatar or even for their real-life selves, building homes, planting gardens, etc., as well as changing the appearance of their avatar. These actions are only illustrative of some possible actions that a user can perform in the virtual universe and are not limiting of the many possible actions that can be performed. A communications interface 48 enables a user to communicate with other users of the virtual universe 12 through modalities such as chatting, instant messaging, gesturing, and electronic mail (e-mail).

FIG. 3 shows the various types of information received by the client management component 40 from the virtual universe through the server array 14. In particular, the client management component 40 receives avatar information about the avatars that are in proximity to the user's avatar. In addition, the client management component 40 receives location information about the area that the user's avatar is near (e.g., where he or she is) as well as scene information (e.g., what the avatar sees). The client management component 40 also receives proximity information which contains information on what the user's avatar is near and object information which is information that can be obtained by one's senses (e.g., touch, taste, smell, etc.,) and what actions are possible for nearby objects (e.g., copy, purchase, etc.). FIG. 3 also shows the movement commands and action commands that are generated by the user are sent to the server array via the client management component 40, as well as the communications that can be sent to the users of other avatars within the virtual universe.

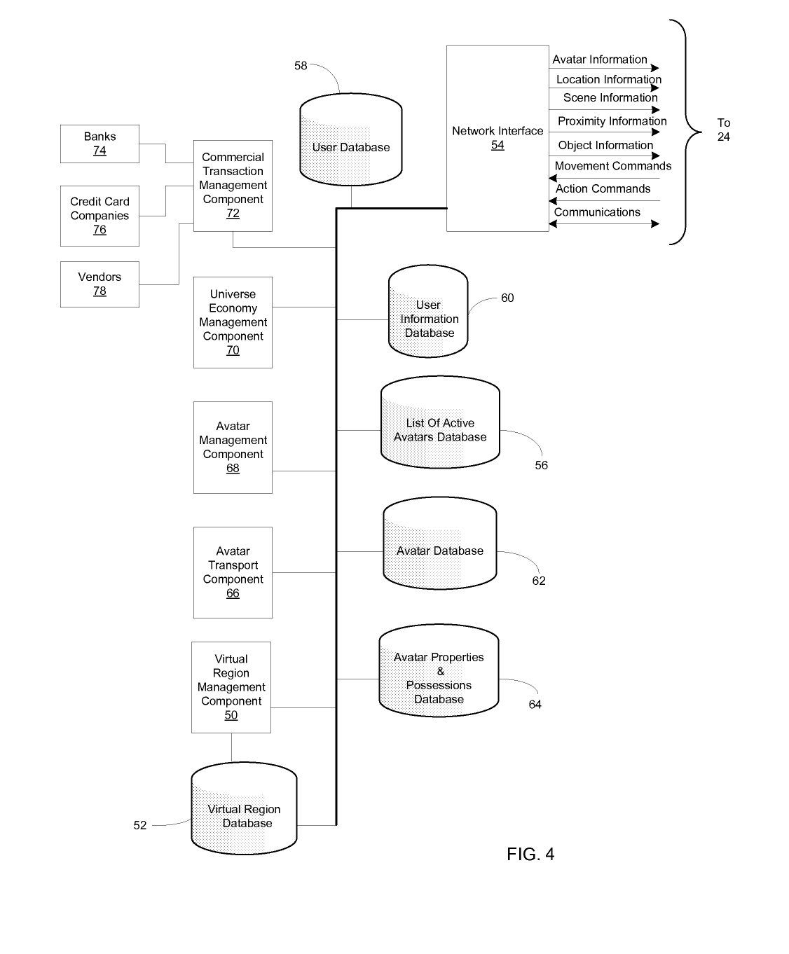

FIG. 4 shows a more detailed view of some the functionalities provided by the server array 14 shown in FIG. 1. In particular, FIG. 4 shows a virtual region management component 50 that manages a virtual region within the virtual universe. In particular, the virtual region management component 50 manages what happens in a particular region such as the type of landscape in that region, the amount of homes, commercial zones, boutiques, streets, parks, restaurants, etc. Those skilled in the art will recognize that the virtual region management component 50 can manage many other items within the virtual region. A virtual region database 52 stores information on all of the items in the virtual region 18 that the virtual region management component 50 is managing. In one embodiment, for very large virtual universes, one server 16 may be responsible for managing one particular virtual region 18 within the universe.

FIG. 4 shows a network interface 54 that enables the server array 14 to interact with the virtual universe client 24 residing on computer 20. In particular, the network interface 54 communicates avatar, location, scene, proximity and object information to the user through the virtual universe client 24 and receives movement and action commands as well as communications from the user via the universe client.

A virtual region database 52 stores information on all of the items in the virtual region 18 that the virtual region management component 50 is managing. In one embodiment, for very large virtual universes, one server 16 may be responsible for managing one particular virtual region 18 within the universe. In other embodiments, it is possible that one server 16 may be responsible for handling one particular island within the virtual region 18.

As shown in FIG. 4, there are several different databases for storing information. In particular, database 56 contains a list of all the avatars that are online in the virtual universe 12. Databases 58 and 60 contain information on the actual human users of the virtual universe 12. In one embodiment, database 58 contains general information on the users such as names, addresses, interests, ages, etc., while database 60 contains more private information on the users such as email addresses, billing information (e.g., credit card information) for taking part in transactions. Databases 62 and 64 contain information on the avatars of the users that reside in the virtual universe 12. In one embodiment, database 62 contains information such as all of the avatars that a user may have, the profile of each avatar, while database 64 contains a listing of properties and possessions that each avatar owns such as houses, cars, sporting equipment, appearance, attire, etc. Those skilled in the art will recognize that databases 58-64 may contain additional information if desired. Although the above information is shown in FIG. 4 as being stored in databases, those skilled in the art will recognize that other means of storing information can be utilized.

An avatar transport component 66 enables users to transport or teleport, which as mentioned above, allows avatars to transport through space from one point to another point, instantaneously. As a result, an avatar could for example go from the mines in Tahawus, New York to a mango sales convention in Nicaragua or to leave the Northeast Kingdom of Vermont to go to Coober Pedy in Australia to hear a sales pitch to buy opals.

An avatar management component 68 keeps track of what online avatars are doing while in the virtual universe. For example, the avatar management component 68 can track where the avatar presently is in the virtual universe, what activities it is performing or has recently performed. An illustrative but non-exhaustive list of activities can include shopping, eating, talking, recreating, teleporting, etc.

Because a typical virtual universe has a vibrant economy, the server array 14 has functionalities that are configured to manage the economy. In particular, a universe economy management component 70 manages transactions that occur within the virtual universe between avatars. In one embodiment, the virtual universe 12 will have their own currency that users pay for with real-life money. The users can then take part in commercial transactions for their avatars through the universe economy management component 70. For example, an avatar might want to buy a surfboard so that it can go surfing. In this case, the avatar would make the purchase using the virtual universe currency to make the purchase. In some instances, the user may want to take part in a commercial transaction that benefits him or her and not their avatar. In this case, a commercial transaction management component 72 allows the user to participate in the transaction. For example, while walking around a commercial zone, an avatar may see a pair of shoes that he or she would like for themselves and not their avatar. Another example would include an avatar accepting an offer of transport to a region in the virtual universe where seaweed is sold. The avatar after receiving the sales pitch in this seaweed region could decide to buy one ton of seaweed. In order to fulfill these transactions and others similarly related, the commercial transaction management component 72 interacts with banks 74, credit card companies 76 and vendors 78 to facilitate the transactions.

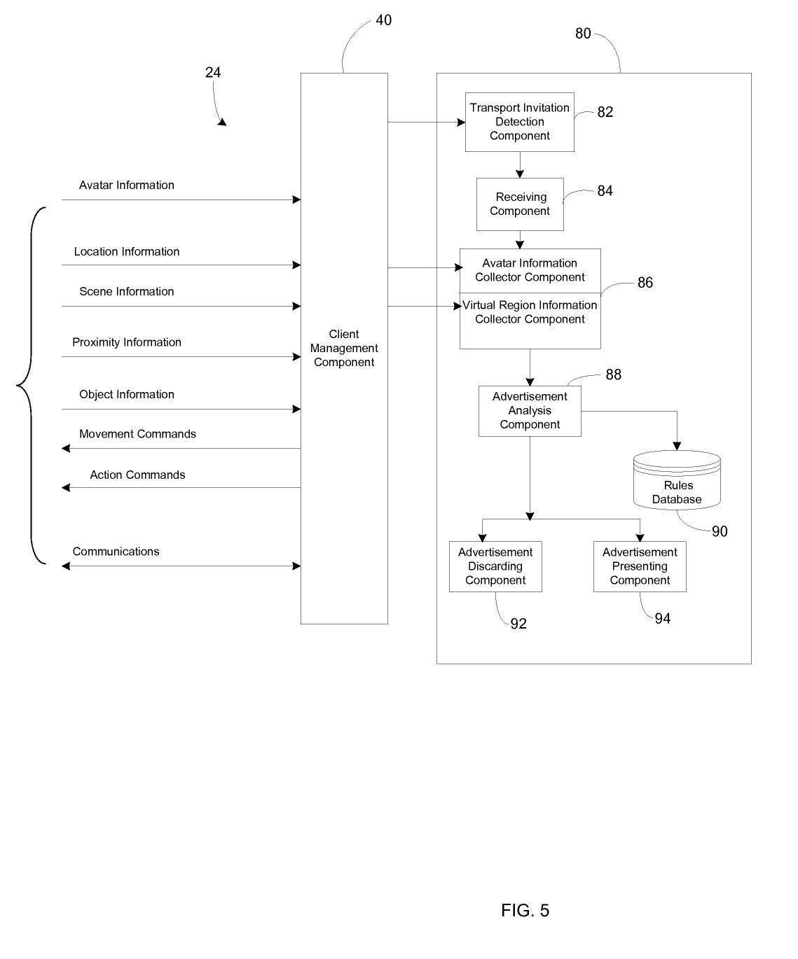

FIG. 5 shows an advertising amelioration tool 80 according to one embodiment of this invention that operates in the environment of FIG. 1. In particular, the advertising amelioration tool 80 ameliorates an offer of transport that an avatar online in a virtual universe receives from another avatar online in the universe for teleporting to another virtual region within the universe for exposure to an unsolicited advertisement. Those skilled in the art will recognize that the avatar that is offering an invitation to teleport to another virtual region is not limited to a virtual representation of a human user, but may be an avatar that is a front for an “artificial intelligence” entity such as a software program to designed to act (e.g., make offers of transports to commercial regions) along predetermined paths according to predetermined rules patterns.

The virtual region that is the subject of the offer of transport may be any region in which advertisements and/or other offers for sale can be made to any avatar entering such region. In one embodiment, the virtual universe 12 can have designated commercial regions or advertising regions where it is plainly apparent to any avatar entering the region that they will be exposed to advertisements, receive product literature or be asked to make evaluations or purchases for goods or services. Such regions may have names signifying their relationship with their sponsor (e.g., “Acme Corporation Region”), or relatively ambiguous names (e.g., “Paradise Island”) designed to obscure the relationship between the region and the sponsor. The region could be constructed to be analogous to real world commercial settings, such as marketplaces, convention centers, boutiques, etc. In another embodiment, it is also possible that these offers of transports could be to less structured locations such as a street corner or in a park where another avatar wants to sell goods or services to another.

Although this invention that follows pertains to ameliorating unsolicited advertisements made through offers of transport, this invention is applicable to other scenarios that could result after accepting an offer of transport to a virtual region. For example, it is conceivable that unsavory avatars may use offers of transport to irritate, confuse, trap, or injure another avatar. The principles of this invention could be use to discriminate these types of offers of transport and prevent them from being received by the targeted avatars.

As shown in FIG. 5, in this embodiment, the advertising amelioration tool 80 resides on the same computer system as the virtual universe client 24 and communicates directly to the virtual universe and its denizens via the virtual universe client 24. In other embodiments, the advertising amelioration tool 80 might reside on the same computers as the virtual universe servers 16, or reside on separate computers in direct communication with the virtual universe servers 16.

Referring back to FIG. 5, the advertising amelioration tool 80 comprises a transport invitation detection component 82 configured to detect an offer of transport to a virtual region within the virtual universe that is made from one avatar to another avatar. After the transport invitation detection component 82 has detected the offer of transport it will then intercept the offer before it goes unfettered to the targeted avatar.

A receiving component 84 receives the offer of transport from the advertisement detection component 82 and does an initial review and preprocessing of the offer. The initial review and preprocessing may include operations such as identifying from whom the invitation is being sent, and to what location the invitation to transport relates. Note that the functions performed by the transport invitation detection component 82 and the receiving component 84 may be done in one component.

An information collector component 86 that comprises an avatar information collector component and a virtual region information collector component collects information from the server array 14 with respect to the avatar that is offering the invitation to transport and the virtual region that is the subject of the offer of transport. In particular, the avatar information collector component is configured to retrieve information on the offering avatar that comprises immediately available information, historical information or information ascertained through an independent source. Immediately available information comprises information such as avatar name, current location, group memberships, and accessible information about the real human behind the avatar and is retrieved from the server array 14 in one of the databases 56-64 (FIG. 4). Historical information could include information such as avatar creation date, complaints, violent acts, etc., and is retrieved from one of the databases 56-64 (FIG. 4) in the server array 14. Information ascertained through an independent source could be a third party such as a consulting company that has information about the avatars that are residents of the virtual universe that could be made available for a fee or a subscription.

The virtual region information collector component is configured to retrieve information on the virtual region that is subject to the offer of transport and comprises information that is publicly available and/or information immediately ascertained through a visit to the virtual region. Publicly available information would include information such as requirements for entering the virtual region, a description of the region, activites that are permitted in the region, what are other regions that are nearby, etc., and is retrieved from one of the databases 56-64 (FIG. 4) in the server array 14. Information that is ascertained directly from the virtual region can include information that details what is currently in the region, what activites are currently occurring in the region, and how many avatars are presently in the region. A bot or drone that has a function to go directly to regions within the virtual universe and obtain information therefrom can obtain this information.

An advertisement analysis component 88 is configured to receive the information from the information collector component 86 and determine whether to present the offer of transport to the avatar targeted to receive the unsolicited advertisement. In particular, the advertisement analysis component 88 analyzes the information collected on the avatar generating the offer of transport and the virtual region that is subject to the offer of transport. The analysis of the information collected on the avatar generating the offer of transport includes identity, current location, history, activities, and relationships of the avatar, whereas the analysis of the information collected on the virtual region that is subject to the offer of transport includes the ownership, contents, residents, and current occupants of the region, as well as the primary purpose, current activities in the region, and history of activities in the region

The advertisement analysis component 88 analyzes the information collected on the offering avatar and the virtual region in accordance with a predetermined set of rules stored in rules database 90. In one embodiment, the rules database would have one set of rules that relate specifically to avatars offering teleportation and another set of rules that relate to virtual regions. There would also be another set of rules that would arbitrate a decision from the outcome of the rules that indicates how to manage the offer of transport. Examples of some rules that could be used are immediate discard of invitations from avatars with which the user does not have an existing relationship, has not designated as a “friend,” or has never had a conversation or encounter previously. Other rules would cause immediate discard of invitations from avatars who are members of certain groups, or are not members of certain groups, or avatars who carry certain designations (such as frequent advertiser, known annoyance) as categorized in public or private, internal or external databases. Other rules would cause immediate discard of invitations from avatars that are currently located in certain regions (such as known commercial zones or inappropriate zones) as categorized in public or private, internal or external databases. Other rules would cause automatic discard based on information about the transport target region. These could include discard based on the name of the region, the ownership of the region, the contents of the region (names of buildings, establishments, etc.,) the current occupants of the region, etc. Those skilled in the art will recognize that one set of rules for both the offering avatar and the virtual region could be used to generate a decision how to manage the offer of transport. Also, those skilled in the art will recognize that the predetermined set of rules could be in the form of a table or a list stored in the advertisement analysis component 88.

The advertisement analysis component 88 then uses the rules to make a decision on how to handle the offer of transport. In one embodiment, the advertisement analysis component 88 could decide to discard the offer of transport, deliver the offer of transport to the targeted avatar or deliver the offer of transport to the target avatar with information collected from the information collection component 86 that would assist the avatar in deciding whether to ultimately accept or reject the offer of transport. Such other information could include a picture or audio file of the virtual location that it has been taken in real time, avatar “ratings” of the virtual location, an assessment of the virtual location including rendering responsiveness, resource usage, number of avatars at the location, etc., and an assessment of the avatars that are at the virtual location.

Those skilled in the art will recognize that there are other approaches to handling the offer of transport. For example, the advertisement analysis component 88 could deliver the offer of transport to the targeted avatar with a warning or graphical indication indicating that it may not be an offer of transport that is suitable for the avatar, place the offers of transport from unknown or suspected spammers into a holding queue for the receiving avatar to examine later and place the offering avatar and location that is subject of the offer on a list or table that represent avatars and regions within the virtual universe that are known as spammers or areas where illicit or unsavory activities occur that can be referred to when evaluating future offers of transport.

Depending on the decision determined by the advertisement analysis component 88, either the advertisement discarding component 92 or advertisement presenting component 94 will be activated. If the advertisement analysis component 88 decides to discard the offer of transport because it is unsuitable to present to the targeted avatar, then the advertising discarding component 92 will discard the offer of transport. If the advertisement analysis component 88 decides that the offer of transport is suitable for the targeted avatar, then the advertisement presenting component 94 will present the offer of transport. In one embodiment, the advertisement presenting component 94 may include additional information such as the items mentioned above. The avatar can use this additional information to decide whether to accept the offer of transport.

FIG. 5 shows some of the processing functions associated with using the advertising amelioration tool 80 to mitigate offers of transport to avatars that culminate in an unsolicited advertisement to the avatars. In this regard, each block in the tool represents a component and a process act associated with performing these functions. It should also be noted that in some alternative implementations, the acts noted in the blocks may occur out of the order noted in the figure or, for example, may in fact be executed substantially concurrently or in the reverse order, depending upon the act involved. Also, one of ordinary skill in the art will recognize that additional blocks that describe these processing acts may be added.

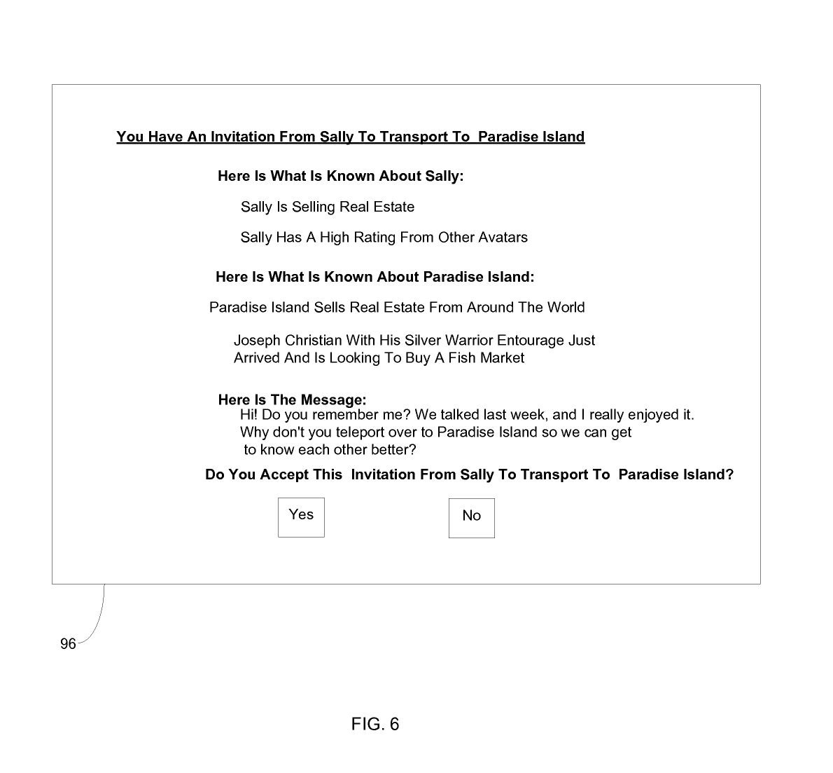

FIG. 6 shows an example of a graphic user interface panel 96 generated from the advertising amelioration tool 80. In particular, the graphic user interface panel 96 is generated from the advertisement presenting component 94 and in this example provides additional information that the receiving avatar can use to decide in whether to accept or reject the offer.

In FIG. 6, the panel indicates that there is an invitation from Sally to transport to Paradise Island. The panel provides information that is known about the avatar Sally (i.e., she sells real estate and has a high rating from avatars) and provides information about the virtual region, Paradise Island (i.e., Paradise Island sells real estate from around the world and that Joe Christian and others are presently there). In addition, the panel lists the message that Sally has provided with the offer for transport (i.e., Hi! Do you remember me? We talked last week, and I really enjoyed it. Why don't you teleport over to Paradise Island so we can get to know each other better?). At the bottom of the panel, the avatar is asked whether he or she wants to accept this offer of transport to Paradise Island.

Those skilled in the art will recognize that this example provided in FIG. 6 is only illustrative of one type of panel that could be generated and is not meant to limit the invention described herein. For example, the control panel can have additional buttons for propagating the filtering provided by the advertising amelioration tool 80. In one embodiment, there could be a button that requests that the avatar never receive an offer of transport from the offering avatar or another button that requests that the avatar never receive and offer of transport from the virtual region that is subject to the offer.

In another embodiment of this invention, the advertising amelioration tool 80 could be used as a service to charge fees for preventing unsolicited offers of transport for exposure to advertisements. In this embodiment, the provider of the virtual universe or a third party service provider could offer this advertising amelioration tool 80 as a service by performing the functionalities described herein on a subscription and/or fee basis. In this case, the provider of the virtual universe or the third party service provider can create, deploy, maintain, support, etc., the advertising amelioration tool 80 that performs the processes described in the invention. In return, the virtual universe or the third party service provider can receive payment from the virtual universe residents via the universe economy management component 70 and the commercial transaction management component 72.

In still another embodiment, the methodologies disclosed herein can be used within a computer system to prevent unsolicited offers of transport for exposure to advertisements. In this case, the advertising amelioration tool 80 can be provided and one or more systems for performing the processes described in the invention can be obtained and deployed to a computer infrastructure. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

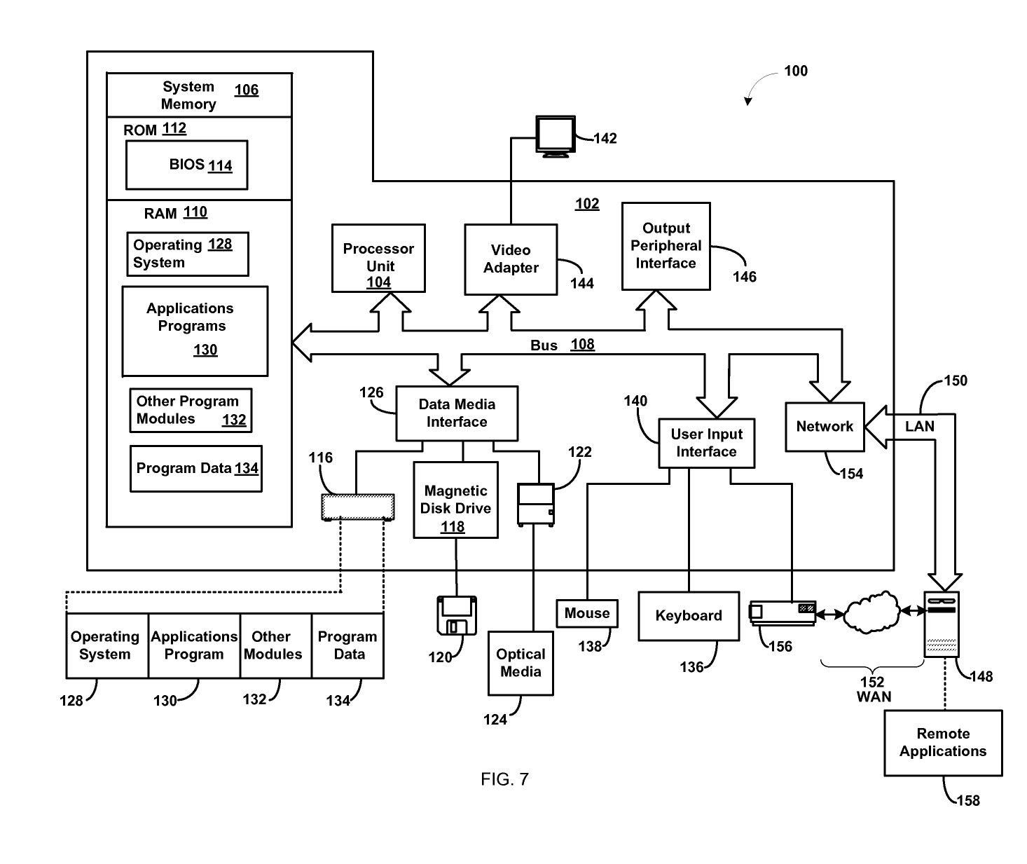

FIG. 7 shows a schematic of an exemplary computing environment in which elements of the networking environment shown in FIG. 1 may operate. The exemplary computing environment 100 is only one example of a suitable computing environment and is not intended to suggest any limitation as to the scope of use or functionality of the approach described herein. Neither should the computing environment 100 be interpreted as having any dependency or requirement relating to any one or combination of components illustrated in FIG. 7.

In the computing environment 100 there is a computer 102 which is operational with numerous other general purpose or special purpose computing system environments or configurations. Examples of well known computing systems, environments, and/or configurations that may be suitable for use with an exemplary computer 102 include, but are not limited to, personal computers (PC), server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The exemplary computer 102 may be described in the general context of computer-executable instructions, such as program modules, being executed by a computer. Generally, program modules include routines, programs, objects, components, logic, data structures, and so on, that performs particular tasks or implements particular abstract data types. The exemplary computer 102 may be practiced in distributed computing environments where tasks are performed by remote processing devices that are linked through a communications network. In a distributed computing environment, program modules may be located in both local and remote computer storage media including memory storage devices.

As shown in FIG. 7, the computer 102 in the computing environment 100 is shown in the form of a general-purpose computing device. The components of computer 102 may include, but are not limited to, one or more processors or processing units 104, a system memory 106, and a bus 108 that couples various system components including the system memory 106 to the processor 104.

Bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 102 typically includes a variety of computer readable media. Such media may be any available media that is accessible by computer 102, and it includes both volatile and non-volatile media, removable and non-removable media.

In FIG. 7, the system memory 106 includes computer readable media in the form of volatile memory, such as random access memory (RAM) 110, and/or non-volatile memory, such as ROM 112. A BIOS 114 containing the basic routines that help to transfer information between elements within computer 102, such as during start-up, is stored in ROM 112. RAM 110 typically contains data and/or program modules that are immediately accessible to and/or presently operated on by processor 104.

Computer 102 may further include other removable/non-removable, volatile/non-volatile computer storage media. By way of example only, FIG. 7 illustrates a hard disk drive 116 for reading from and writing to a non-removable, non-volatile magnetic media (not shown and typically called a “hard drive”), a magnetic disk drive 118 for reading from and writing to a removable, non-volatile magnetic disk 120 (e.g., a “floppy disk”), and an optical disk drive 122 for reading from or writing to a removable, non-volatile optical disk 124 such as a CD-ROM, DVD-ROM or other optical media. The hard disk drive 116, magnetic disk drive 118, and optical disk drive 122 are each connected to bus 108 by one or more data media interfaces 126.

The drives and their associated computer-readable media provide nonvolatile storage of computer readable instructions, data structures, program modules, and other data for computer 102. Although the exemplary environment described herein employs a hard disk 116, a removable magnetic disk 118 and a removable optical disk 122, it should be appreciated by those skilled in the art that other types of computer readable media which can store data that is accessible by a computer, such as magnetic cassettes, flash memory cards, digital video disks, RAMs, ROM, and the like, may also be used in the exemplary operating environment.

A number of program modules may be stored on the hard disk 116, magnetic disk 120, optical disk 122, ROM 112, or RAM 110, including, by way of example, and not limitation, an operating system 128, one or more application programs 130, other program modules 132, and program data 134. Each of the operating system 128, one or more application programs 130, other program modules 132, and program data 134 or some combination thereof, may include an implementation of the networking environment 10 of FIG. 1 including the server array 14, the virtual universe client 24 and the advertising amelioration tool 80.

A user may enter commands and information into computer 102 through optional input devices such as a keyboard 136 and a pointing device 138 (such as a “mouse”). Other input devices (not shown) may include a microphone, joystick, game pad, satellite dish, serial port, scanner, camera, or the like. These and other input devices are connected to the processor unit 104 through a user input interface 140 that is coupled to bus 108, but may be connected by other interface and bus structures, such as a parallel port, game port, or a universal serial bus (USB).

An optional monitor 142 or other type of display device is also connected to bus 108 via an interface, such as a video adapter 144. In addition to the monitor, personal computers typically include other peripheral output devices (not shown), such as speakers and printers, which may be connected through output peripheral interface 146.

Computer 102 may operate in a networked environment using logical connections to one or more remote computers, such as a remote server/computer 148. Remote computer 148 may include many or all of the elements and features described herein relative to computer 102.

Logical connections shown in FIG. 7 are a local area network (LAN) 150 and a general wide area network (WAN) 152. Such networking environments are commonplace in offices, enterprise-wide computer networks, intranets, and the Internet. When used in a LAN networking environment, the computer 102 is connected to LAN 150 via network interface or adapter 154. When used in a WAN networking environment, the computer typically includes a modem 156 or other means for establishing communications over the WAN 152. The modem, which may be internal or external, may be connected to the system bus 108 via the user input interface 140 or other appropriate mechanism.

In a networked environment, program modules depicted relative to the personal computer 102, or portions thereof, may be stored in a remote memory storage device. By way of example, and not limitation, FIG. 7 illustrates remote application programs 158 as residing on a memory device of remote computer 148. It will be appreciated that the network connections shown and described are exemplary and other means of establishing a communications link between the computers may be used.

An implementation of an exemplary computer 102 may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable media containing computer instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this invention an approach for amelioration of unsolicited advertisements in a virtual universe through avatar transport offers. While the invention has been particularly shown and described in conjunction with a preferred embodiment thereof, it will be appreciated that variations and modifications will occur to those skilled in the art. Therefore, it is to be understood that the appended claims are intended to cover all such modifications and changes as fall within the true spirit of the invention.

What is claimed is:

1. A method for ameliorating an offer of transport that a first avatar online in a virtual universe receives from a second avatar online in the virtual universe for teleporting to another virtual region within the virtual universe for exposure to an unsolicited advertisement, comprising:
detecting that the second avatar has sent the first avatar the offer of transport to the virtual region for exposure to the unsolicited advertisement; and
determining whether to present the offer of transport to the first avatar.

2. The method according to claim 1, further comprising collecting information on the second avatar.

3. The method according to claim 2, wherein the collecting of information on the second avatar comprises retrieving information relating to the second avatar that comprises at least one of immediately available information, historical information or information ascertained through an independent source.

4. The method according to claim 2, further comprising analyzing the collected information on the second avatar.

5. The method according to claim 1, further comprising collecting information on the virtual region that is presented in the offer of transport.

6. The method according to claim 5, further comprising retrieving information on the virtual region that comprises at least one of publicly available information and information immediately ascertained through a visit to the virtual region.

7. The method according to claim 5, further comprising analyzing the collected information on the virtual region.

8. The method according to claim 1, further comprising collecting information on the second avatar and information on the virtual region that is presented in the offer of transport.

9. The method according to claim 8, further comprising analyzing the collected information on the second avatar and the virtual region in accordance with a predetermined set of rules.

10. The method according to claim 1, further comprising discarding the offer of transport in response to a determination that the offer of transport is unsuitable to present to the first avatar.

11. The method according to claim 1, further comprising presenting the offer of transport with additional information to aid the first avatar in deciding whether to accept the offer of transport in response to a determination that the offer of transport is suitable to present to the first avatar.

12. The method according to claim 1, further comprising presenting the offer of transport to the first avatar in response to a determination that the offer of transport is suitable to present to the first avatar.

13. An advertising amelioration tool for use in a virtual universe, comprising:
a transport invitation detection component configured to detect an offer of transport to a virtual region within the virtual universe for exposure to an unsolicited advertisement; and
an advertisement analysis component configured to determine whether to present the offer of transport to an avatar targeted to receive the unsolicited advertisement.

14. The advertising amelioration tool according to claim 13, further comprising an information collection component configured to collect information on an avatar responsible for generating the offer of transport and information on the virtual region that is presented in the offer of transport.

15. The advertising amelioration tool according to claim 14, wherein the information collection component is configured to retrieve information on the avatar responsible for the offer that comprises at least one of immediately available information, historical information or information ascertained through an independent source.

16. The advertising amelioration tool according to claim 14, wherein the information collection component is configured to retrieve information on the virtual region that comprises at least one of publicly available information and information immediately ascertained through a visit to the virtual region.

17. The advertising amelioration tool according to claim 14, wherein the advertisement analysis component is configured to analyze the information collected on the offering avatar and the virtual region in accordance with a predetermined set of rules

18. The advertising amelioration tool according to claim 13, further comprising an advertisement discarding component configured to discard the offer of transport in response to a determination that the offer of transport is unsuitable to present to the targeted avatar.

19. The advertising amelioration tool according to claim 13, further comprising an advertisement presenting component configured to present the offer of transport to the targeted avatar with additional information to aid in deciding whether to accept the offer of transport, wherein the advertisement presenting component presents the offer of transport with additional information in response to a determination that the offer of transport is suitable to present to the targeted avatar.

20. The advertising amelioration tool according to claim 13, further comprising an advertisement presenting component configured to present the offer of transport to the targeted avatar in response to a determination that the offer of transport is suitable to present to the targeted avatar.

21. A computer-readable medium storing computer instructions, which when executed, enables a computer system to ameliorate an offer of transport made to a first avatar online in a virtual universe from a second avatar online in the virtual universe for teleporting to another virtual region within the virtual universe for exposure to an unsolicited advertisement, the computer instructions comprising:
detecting that the second avatar has sent the first avatar the offer of transport to the virtual region for exposure to the unsolicited advertisement;
receiving the offer of transport to the virtual region for exposure to the unsolicited advertisement from the second avatar; and
determining whether to present the offer of transport to the first avatar.

22. The computer-readable medium according to claim 21, further comprising instructions for collecting information on the second avatar and information on the virtual region that is presented in the offer of transport.

23. The computer-readable medium according to claim 22, wherein the collecting of information on the second avatar comprises instructions for retrieving information on the second avatar that comprises at least one of immediately available information, historical information or information ascertained through an independent source.

24. The computer-readable medium according to claim 22, comprises instructions for retrieving information on the virtual region that comprises at least one of publicly available information and information immediately ascertained through a visit to the virtual region.

25. A method for deploying an advertising amelioration tool for use in a computer system that ameliorates an offer of transport that a first avatar online in a virtual universe receives from a second avatar online in the virtual universe for teleporting to another virtual region within the virtual universe for exposure to an unsolicited advertisement, comprising:
providing a computer infrastructure operable to:
detect that the second avatar has sent the first avatar the offer of transport to the virtual region for exposure to the unsolicited advertisement; and
determine whether to present the offer of transport to the first avatar.
